(19) United States
(12) Patent Application Publication
(10) Pub. No.: US 2009/0103755 A1
(43) Pub. Date: Apr. 23, 2009

(54) Receiver

(76) Inventors: Wai Kit David Ho, Singapore (SG); Wee Haw Koo, Singapore (SG); Berg Hai Tan, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/990,676

(22) PCT Filed: Aug. 31, 2005
(86) PCT No.: PCT/SG2005/000296

§ 371 Date: Feb. 19, 2008

(51) Int. Cl. H04R 25/00

(52) U.S. Cl. 381/322

(57) ABSTRACT

A receiver for a hearing aid device that converts input electric signals, generated by a solenoid located adjacent a proximate region of a casing of the receiver, to acoustic waves which are emitted from an output of the casing remote from the proximate region, wherein the receiver is adapted to allow the input signals to be fed into the casing at a location spaced from the solenoid and towards the output of the receiver.

### CROSS REFERENCE TO RELATED APPLICATIONS

This application is the US National Stage of International Application No. PCT/SG2005/000296, filed Aug. 31, 2005 and claims the benefit thereof. The International Application is incorporated by reference herein in its entirety.

### TECHNICAL FIELD OF THE INVENTION

The present invention relates to a receiver for a hearing aid device.

### BACKGROUND OF THE INVENTION

A hearing aid device typically includes a microphone, an amplifier, and a receiver. The microphone detects sound waves external to the device and generates electric signals representing those sound waves. The electric signals are amplified and processed by the amplifier and the receiver generates sound waves representing the amplified electric signals. The hearing aid device shown in FIG. 1 shows a typical arrangement of the above components. The components are arranged to make best use of the minimal internal space available.

The receiver includes, amongst other things, an electromagnetic coil that generates a magnetic field in accordance with the mentioned amplified electric signals, and a diaphragm that generates sound waves in accordance with changes in the magnetic field. The sound waves are channeled out of the receiver, through the outlet, into an ear of a person.

The magnetic field generated by the electromagnetic coil may adversely effect the performance of other components in the electric circuit of the hearing aid device. For this reason, the components of the receiver are typically arranged inside an electrically conductive metal casing that acts to contain the magnetic field. The metal casing functions as a Faraday cage that shields the other components from the magnetic field generated by the receiver.

The casing has previously included apertures through which electrically conductive solder pads coupled to the electromagnetic coil receive the amplified electric signal from the amplifier. These apertures have previously been located on a back wall of the metal casing, as shown in FIG. 1, that is proximal to the amplifier to minimise the distance therebetween.

The electrically conductive casing for the receiver generally inhibits the passage of electromagnetic waves through the receiver. However, the receiver has previously leaked magnetic flux through the openings for the solder pads. This leakage can interfere with and degrade the quality and performance of other components of the device.

The solder pads of the receiver of the hearing aid device shown in FIG. 1 are located on a back wall of the receiver, proximal to the amplifier. As such, magnetic flux leakage from the receiver is directed towards the amplifier. The flux leakage may not necessarily adversely effect the performance of the amplifier. However, the leakage would likely effect the performance of the other components, such as the telecoil, located next to the amplifier. As above-mentioned, the limited size of the hearing aid device necessitates close arrangement of the components of the device. As such, relocation of the telecoil, for example, to reduce the effects magnetic flux leakage from the receiver may not be possible.

The telecoil provides an alternative input to the hearing aid. The telecoil typically includes a coil of wire around a core, ie a solenoid, which will induce an electric current in the coil when the coil is in the presence of a changing magnetic field. A telecoil can be used as an alternate or supplemental input device for a hearing aid. Normally, a hearing aid “listens” with its microphone, then amplifies what it “hears”. A telecoil is used as the input source instead of, or in addition to, the microphone so that the hearing aid can “hear” a magnetic signal which represents sound.

Hearing aid devices have also previously included another layer of magnetic shielding to protect components from the mentioned magnetic flux leakage. Hearing aid devices have also previously included an electromagnetic compensator to compensate for the magnetic flux leakage. However, the additional components may occupy valuable real estate inside the hearing aid devices and may add to the cost and complexity of their construction.

It is generally desirable to overcome or ameliorate one or more of the above mentioned difficulties, or at least provide a useful alternative.

### SUMMARY OF THE INVENTION

In accordance with one aspect of the present invention, there is provided a receiver for a hearing aid device that converts input electric signals, generated by a solenoid located adjacent a proximate region of a casing of the receiver, to acoustic waves which are emitted from an output of the casing remote from the proximate region, wherein the receiver is adapted to allow the input signals to be fed into the casing at a location spaced from the solenoid and towards the output of the receiver.

Preferably, said location spaced from the solenoid is proximal to the output.

In accordance with another aspect of the present invention, there is provided a receiver for a hearing aid device, including:
(a) an electromagnetic coil for receiving electric signals and inducing a magnetic field in accordance with said signals;
(b) a diaphragm responsive to changes in said magnetic field so as to generate audible sound waves representing said electric signals;
(c) a tube for receiving said sound waves and channeling said sound waves into the hearing aid device in a predetermined direction; and
(d) a casing adapted to substantially contain said magnetic field within the receiver,
   wherein the receiver is adapted to receive said electric signals through a side of the casing that opens in said predetermined direction.

In accordance with yet another aspect of the present invention, there is provided a receiver for a hearing aid device, the hearing aid device including:
(a) a solenoid for detecting changes in a magnetic field external to the device and generating electric signals representing said changes in the magnetic field; and
(b) said receiver for receiving said electric signals and generating audible sound waves representing said electric signals, said receiver including a casing that inhibits a magnetic field generated by the receiver passing therethrough,
   wherein the receiver receives said electric signals through a side of the casing that is not proximal to said solenoid.

Preferably, said side of the casing includes an aperture through which one or more insulated electrically conductive wires communicating said electric signals can be routed.

Preferably, said aperture is closed by sealing material.

Preferably, said side of the casing includes one or more electrically conductive contacts for receiving said electric signals from the solenoid.

### BRIEF DESCRIPTION OF THE DRAWINGS

Preferred embodiments of the present invention are hereafter described, by way of non-limiting example only, with reference to the accompanying drawing in which:

FIG. 1 is a perspective view of a typical hearing aid device with a section of the housing removed so as to show the internal part of the device;

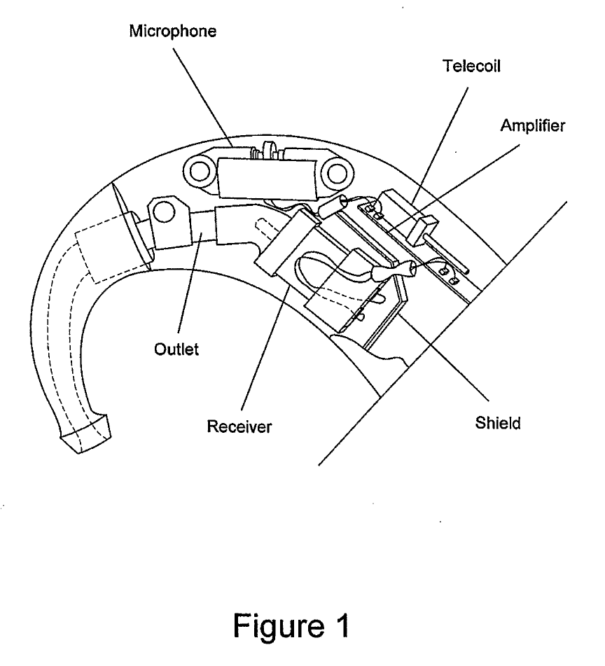

FIG. 2 is a perspective view of a hearing aid device in accordance with a preferred embodiment of the invention with a section of the housing removed so as to show the internal part of the device;

FIG. 3 is perspective view of a receiver of the hearing aid device shown in FIG. 2;

FIG. 4 is a back perspective view of a receiver shown in FIG. 3;

FIG. 5 is a perspective view of a casing of the receiver shown in FIG. 3;

FIG. 6 is a perspective view of an alternative receiver;

FIG. 7 is a back perspective view of a receiver shown in FIG. 6; and

FIG. 8 is a perspective view of a casing of the receiver shown in FIG. 6.

### DETAILED DESCRIPTION OF PREFERRED EMBODIMENTS OF THE INVENTION

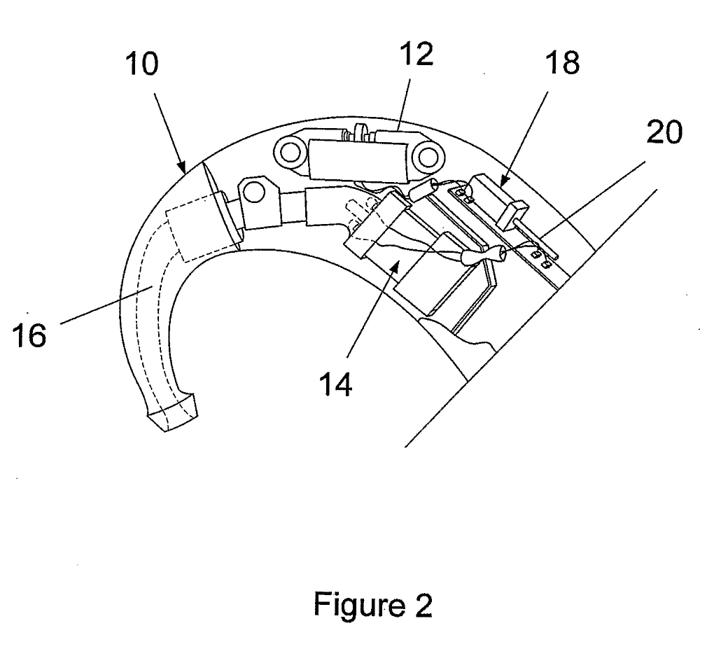

The hearing aid device 10 shown in FIG. 2 includes a microphone 12 for receiving sound waves external to the device 10 and generating electric signals representing those sound waves. The electric signals generated by the microphone 12 are received by an amplifier (not shown) that processes and amplifies the electric signals. A receiver 14 receives the amplified signals from the amplifier and generates audible sound waves representing the amplified electric signals. The hearing aid device 10 directs the sound waves generated by the receiver 14 into a channel 16 that extends into the ear of a person wearing the device 10.

The hearing aid device 10 also includes a telecoil 18 that provides an alternative input to the hearing aid device 10. The telecoil 18 includes a solenoid 20 that induces an electric current when in the presence of a changing magnetic field. The telecoil 18 generates electric signals representing changes in the magnetic field of a speaker in a telephone handset, for example. The electric signals generated by the telecoil 18 are received by an amplifier (not shown) that processes and amplifies the electric signals. The receiver 14 receives the amplified signals from the amplifier and generates audible sound waves representing the amplified electric signals.

The hearing aid device 10 includes a switch (not shown) that is used to select between the input sources of the receiver 14. The telecoil 18 is used as the input source for the receiver 14 instead of, or in addition to, the microphone 12 so that the hearing aid 10 can “hear” a magnetic signal which represents sound.

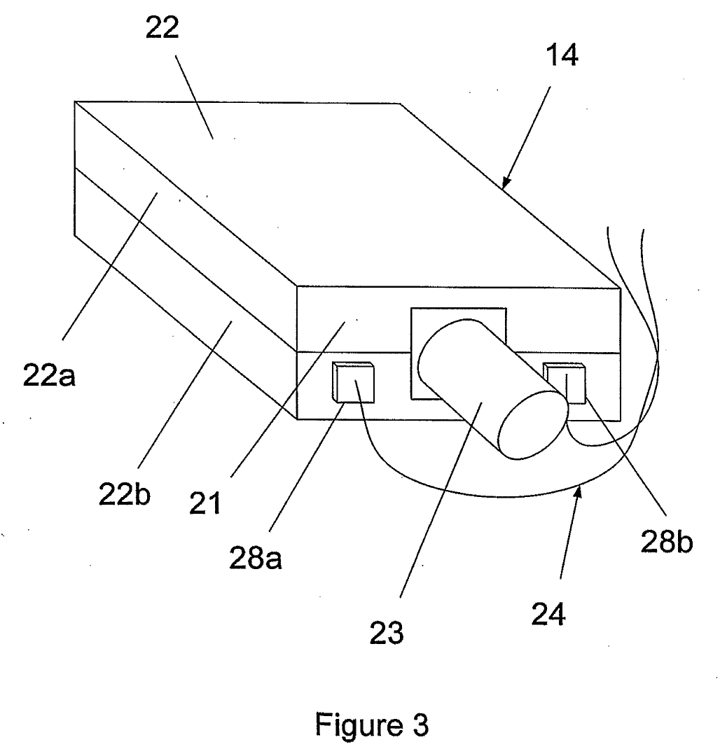

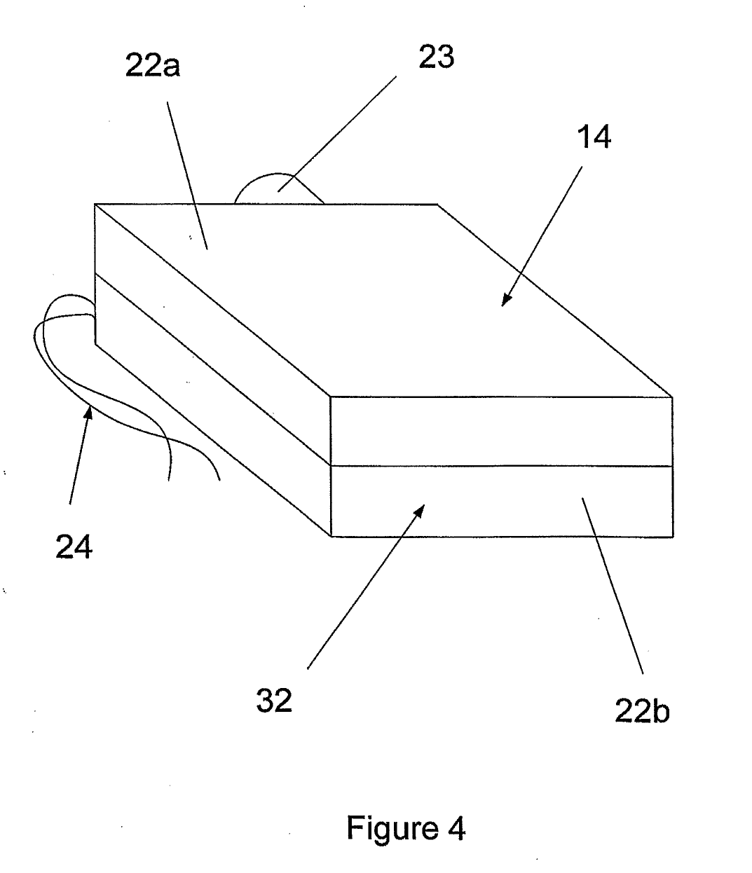

The receiver 14 shown in FIGS. 3 and 4 includes an electromagnetic coil (not shown) that generates a magnetic field in accordance with the amplified electric signals received from the amplifier. The receiver 14 also includes a diaphragm (not shown), the motion of which is controlled by the magnetic field generated by the electromagnetic coil. The diaphragm vibrates air surrounding the diaphragm and produces sound waves representing the amplified electric signals received from either the microphone 12 or the telecoil 18. The sound waves are piped out of the receiver 14, through a cylindrical tube 23 extending from a front side 21 of the receiver 14, into the channel 16. The front side 21 of the receiver 14 generally opens in the direction of the channel 16 so that sound waves exiting the receiver 14 through the cylindrical tube 23 are piped towards the channel 16.

The components of the hearing aid device 10, such as the microphone 12, the amplifier (not shown), and the telecoil 18, have previously been developed and are not described here in detail. These components are preferably arranged within the device 10 in known configurations and communicate using standard techniques.

Similarly, the internal components (not shown) of the receiver 14, such as the electromagnetic coil and the diaphragm, have previously been developed and are not described here in detail. These components are preferably arranged within the receiver 14 in known configurations and communicate using standard techniques.

The mentioned internal components (not shown) of the receiver 14 are arranged inside an electrically conductive casing 22 that functions as a Faraday cage to contain the magnetic field generated by the electromagnetic coil within the receiver 14. The metal casing 22 inhibits the passage of electromagnetic waves there through.

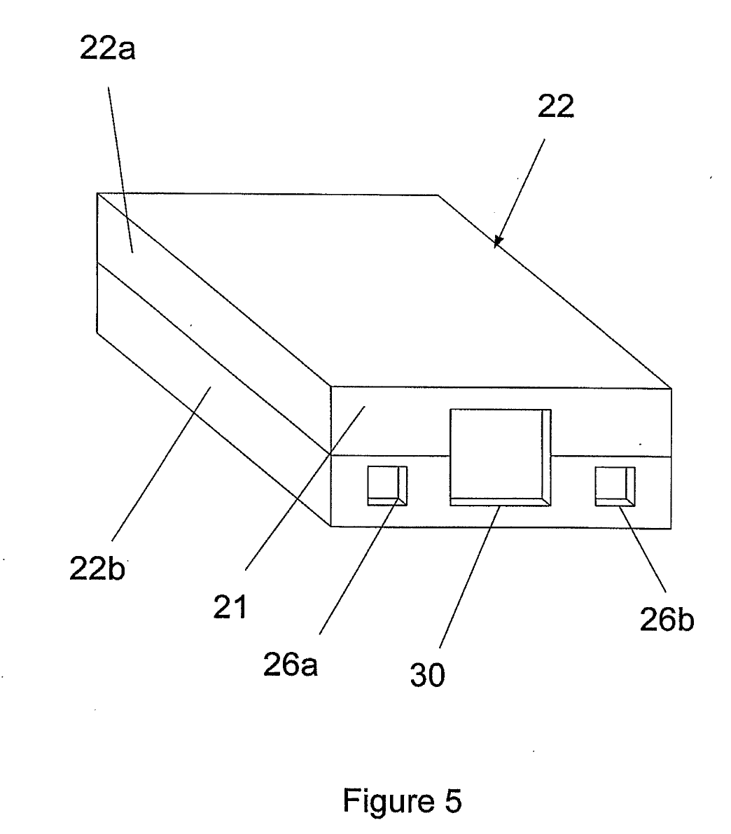

The casing 22 preferably includes upper and lower shells 22a,22b of corresponding shape, as shown in FIG. 5. The internal components of the receiver 14, such as the electromagnetic coil and the diaphragm, are preferably coupled to the lower shell 22b. The upper shell 22a encloses these components within the casing 22 when it is arranged over in the lower shell 22b in the manner shown in FIGS. 3 and 4, for example. The upper and lower shells 22a,22b are preferably welded together. The shells 22a,22b could, alternatively, be coupled together using any suitable means.

The receiver 14 receives electric signals from other components of the hearing aid device 10 by way of electrically conductive wires 24 coupled to the above-mentioned front side 21 of the receiver 14. In doing so, any magnetic flux leakage from the receiver 14 is directed away from the telecoil 18.

The front side 21 of the casing 22 includes left and right apertures 26a,26b that are shaped to receive respective electrically conductive contacts 28a,28b of an electric circuit (not shown) of the receiver 14. The electrically conductive wires 24 are soldered to respective contacts 28a,28b. The contacts 28a,28b interface the internal components of the receiver 14 with the amplifier, for example.

The front side 21 of the casing 22 generally faces in the direction of the channel 16 so that sound waves exiting the receiver 14 through the cylindrical tube 23 are piped into the channel 16. This allows the receiver 14 to leak any magnetic field generated by the electromagnetic coil through the contacts 28a,28b in the direction of the channel 16. The leakage occurs through the front side 21 of the receiver 14, ie through an end of the receiver 14 that is not proximal to the telecoil. The receiver 14 thereby reduces the impact that flux leakage has on the performance of the telecoil.

The front side of the casing 22 also includes an aperture 30 shaped to receive the cylindrical tube 23.

The back wall 32 of the casing 22 of the receiver 14 that is proximal to the telecoil 18 is sealed and shielded against magnetic leakage. The back wall 32 of the casing 22 inhibits magnetic leakage from the receiver 14 in the direction of the telecoil.

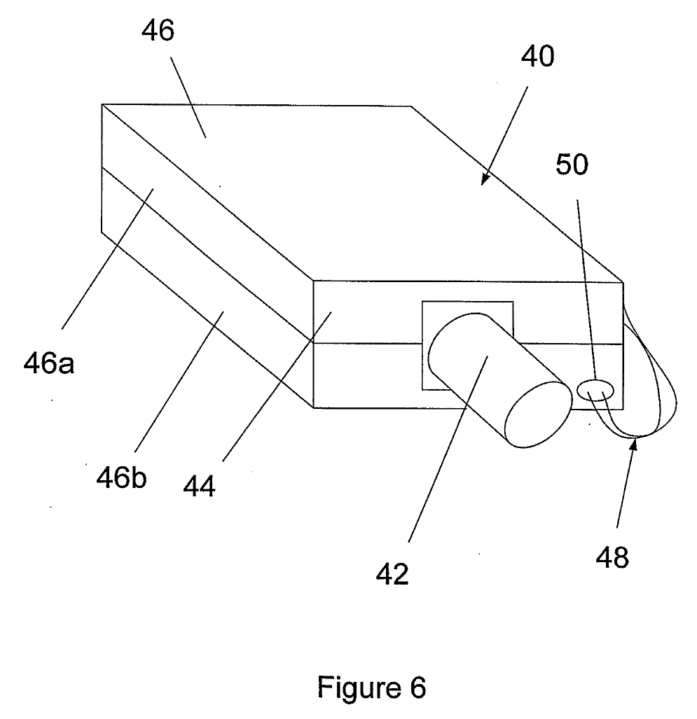

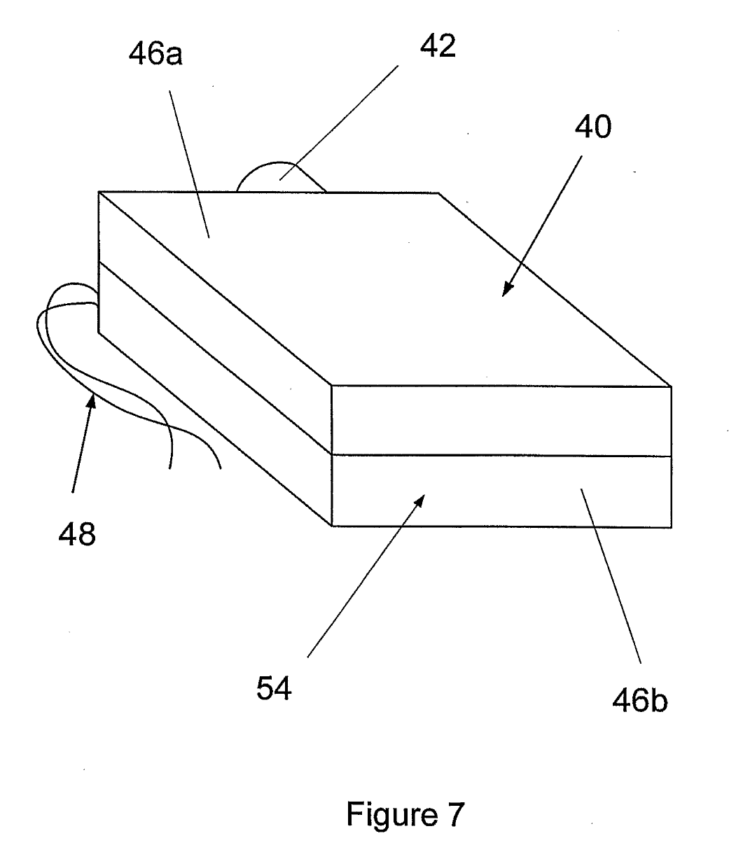

The alternative receiver 40 shown in FIGS. 6 and 7 includes an electromagnetic coil (not shown) that generates a magnetic field in accordance with the amplified electric signals received from the amplifier of the hearing aid device 10 shown in FIG. 2. The receiver 40 also includes a diaphragm (not shown), the motion of which is controlled by the magnetic field generated by the electromagnetic coil. The diaphragm vibrates air surrounding the diaphragm and produces sound waves representing the amplified electric signals received from either the microphone 12 or the telecoil 18 of the hearing aid device 10. The sound waves are piped out of the receiver 40, through a cylindrical tube 42 extending from a front side 44 of the receiver 14, into the channel 16. The front side 44 of the receiver 40 generally opens in the direction of the channel 16 so that sound waves exiting the receiver 40 through the cylindrical tube 42 are piped towards the channel 16.

The internal components (not shown) of the receiver 40, such as the electromagnetic coil and the diaphragm, have previously been developed and are not described here in detail. These components are preferably arranged within the receiver 40 in known configurations and communicate using standard techniques.

The mentioned internal components (not shown) of the receiver 40 are arranged inside an electrically conductive casing 46 that functions as a Faraday cage to contain the magnetic field generated by the electromagnetic coil within the receiver 40. The metal casing 46 inhibits the passage of electromagnetic waves there through.

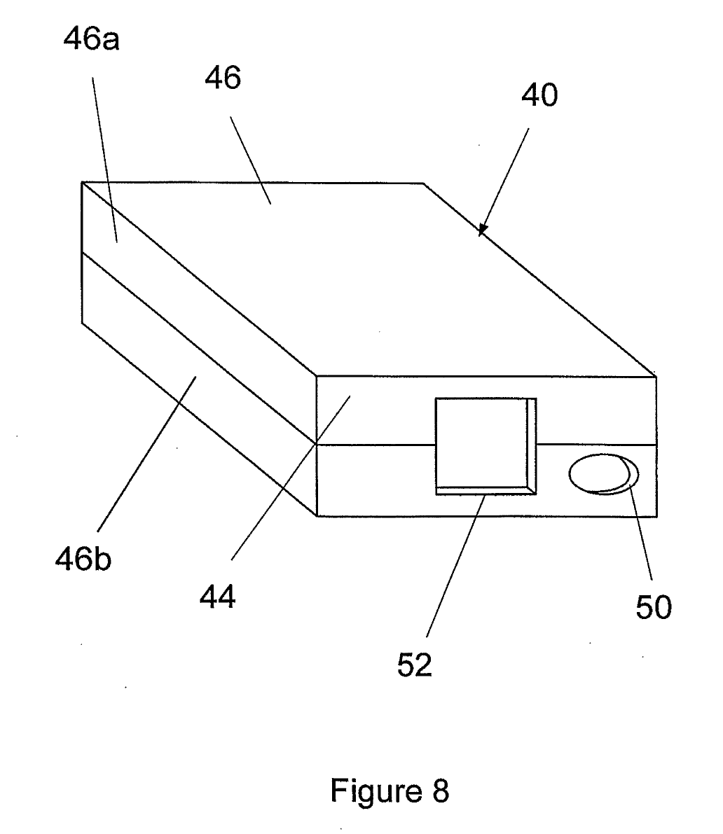

The casing 46 preferably includes upper and lower shells 46a,46b of corresponding shape, as shown in FIG. 8. The internal components of the receiver 40, such as the electromagnetic coil and the diaphragm, are preferably coupled to the lower shell 46b. The upper shell 46a encloses these components within the casing 46 when it is arranged over in the lower shell 46b in the manner shown in FIGS. 6 and 7, for example. The upper and lower shells 46a,46b are preferably welded together. The shells 46a,46b could, alternatively, be coupled together using any suitable means.

The receiver 40 receives electric signals from other components of the hearing aid device 10 by way of electrically conductive wires 48 coupled to the internal components of the receiver 40 through an aperture 50 in the above-mentioned front side 44 of the receiver 40. In doing so, any magnetic flux leakage from the receiver 14 is directed away from the telecoil 18. The aperture 50 is small enough to snugly fit the electrically conductive insulated wires 48 therethrough.

When the hearing aid device 10 is assembled, and the electrically conductive wires are routed through the aperture 50, the aperture 50 is then sealed with a suitable sealing material so as to minimise soundwave leakage from the receiver 40 and to secure the wires 48 in a fixed position.

The front side 44 of the casing 46 generally faces in the direction of the channel 16 so that sound waves exiting the receiver 40 through the cylindrical tube 42 are piped into the channel 16.

The receiver 40 is arranged in the hearing aid device 10 so that the front end 44 of the receiver 40 faces the channel 16 and is not proximal to the telecoil 18.

The front side of the casing 44 also includes an aperture 52 shaped to receive the cylindrical tube 42.

The back wall 54 of the casing 46 of the receiver 40 that is proximal to the telecoil 18 is sealed and shielded against magnetic leakage. The back wall 54 of the casing 46 inhibits magnetic leakage from the receiver 14 in the direction of the telecoil 18.

While we have shown and described specific embodiments of the present invention, further modifications and improvements will occur to those skilled in the art. We desire it to be understood, therefore, that this invention is not limited to the particular forms shown and we intend in the append claims to cover all modifications that do not depart from the spirit and scope of this invention.

1.-11. (canceled)

12. A receiver for a hearing aid device, comprising:
an electromagnetic coil that receives an electric signal and induces a magnetic field in accordance with the electric signal;
a diaphragm that responses to a change in the magnetic field to generate an audible sound wave representing the electric signals;
a tube that receives the sound wave and channels the sound wave into the hearing aid device in a predetermined direction; and
a casing that is adapted to contain the magnetic field within the receiver,
wherein the receiver is adapted to receive the electric signal through a side of the casing that opens in the predetermined direction.

13. The receiver as claimed in claim 12, wherein the side of the casing comprises an aperture through which an insulated electrically conductive wire that communicates the electric signal is routed.

14. The receiver as claimed in claim 13, wherein the aperture is a closed aperture.

15. The receiver as claimed in claim 12, wherein the side of the casing comprises an electrically conductive contact that receives the electric signal.

16. A hearing aid device, comprising:
a solenoid that detects a change in an external magnetic field of the hearing aid device and generates an electric signal representing the;
a receiver that receives the electric signal and generates an audible sound wave representing the electric signal; and
a casing of the receiver that inhibits an internal magnetic field generated by the receiver passing through,
wherein the receiver is adapted to receive the electric signal through a side of the casing that is not proximal to the solenoid.

17. The hearing aid device as claimed in claim 16, wherein the side of the casing comprises an aperture through which an insulated electrically conductive wire for communicating the electric signal is routed.

18. The hearing aid device as claimed in claim 17, wherein the aperture is a closed aperture.

19. The hearing aid device as claimed in claim 16, wherein the side of the casing comprises an electrically conductive contact for receiving the electric signal from the solenoid.

20. The hearing aid device as claimed in claim 16, wherein the receiver comprises a tube for receiving the sound wave and channels the sound wave into the hearing aid device in a direction in which the side of the casing opens.

21. The hearing aid device as claimed in claim 16, wherein the solenoid is a part of a telecoil.
